(19) United States
(12) Patent Application Publication
(10) Pub. No.: US 2020/0336691 A1
(43) Pub. Date: Oct. 22, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Ken NAOE, Kanagawa (JP)

(73) Assignee: FUJI XEROX CO., LTD., Tokyo (JP)

(21) Appl. No.: 16/566,952

(22) Filed: Sep. 11, 2019

(30) Foreign Application Priority Data
Apr. 17, 2019 (JP) 2019-078784

(51) Int. Cl. H04N 5/445; H04N 21/431; H04N 21/4722; H04N 1/00

(52) U.S. Cl. CPC H04N 5/44543; H04N 1/00416; H04N 21/4722; H04N 21/4316

(57) ABSTRACT

An information processing apparatus includes a receiving unit that receives an additional service that is to be added to the information processing apparatus and is not configured for a grant setting of information collection and a controller that, if usage information on the information processing apparatus that is configured for the grant setting of the information collection is similar to usage information on the additional service, performs control to configure at least part of the grant setting of the information collection related to the usage information on the information processing apparatus to be the grant setting of the information collection related to the additional service.

### CROSS-REFERENCE TO RELATED APPLICATIONS

This application is based on and claims priority under 35 USC 119 from Japanese Patent Application No. 2019-078784 filed Apr. 17, 2019.

### BACKGROUND

### (i) Technical Field

The present disclosure relates to an information processing apparatus and a non-transitory computer readable medium.

### (ii) Related Art

Japanese Unexamined Patent Application Publication No. 2017-4175 discloses a management system that includes an information processing apparatus, a management apparatus managing applications of the information processing apparatus, and a delivery apparatus that delivers data of the applications. The information processing apparatus acquires a job related to an application from the management apparatus, performs control on an application of the information processing apparatus in accordance with the acquired job, and modifies in the control at least one of a setting of the information processing apparatus and an application setting of the information processing apparatus in accordance with setting information included in the acquired job.

When an additional service is added to the information processing apparatus, setting information may be directly reflected on the additional service. A grant setting of information collection related to the additional service is difficult to configure by using a grant setting of information collection related to usage information on the information processing apparatus or a grant setting of information collection related to an existing service of the information processing apparatus.

### SUMMARY

Aspects of non-limiting embodiments of the present disclosure relate to enabling an information processing apparatus to configure a grant setting of information collection related to an additional service when the additional service is added to the information processing apparatus by using a grant setting of information collection related to usage information on the information processing apparatus or a grant setting of information collection related to an existing service of the information processing apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus. The information processing apparatus includes a receiving unit that receives an additional service that is to be added to the information processing apparatus and is not configured for a grant setting of information collection and a controller that, if usage information on the information processing apparatus that is configured for the grant setting of the information collection is similar to usage information on the additional service, performs control to configure at least part of the grant setting of the information collection related to the usage information on the information processing apparatus to be the grant setting of the information collection related to the additional service.

### BRIEF DESCRIPTION OF THE DRAWINGS

Exemplary embodiments of the present disclosure will be described in detail based on the following figures, wherein:

FIG. 1 illustrates a hardware configuration of an image processing apparatus of an exemplary embodiment of the disclosure;

FIG. 2 is a block diagram illustrating the image processing apparatus of the exemplary embodiment of the disclosure;

FIG. 3 is a flowchart illustrating an operation example of the image processing apparatus of the exemplary embodiment of the disclosure;

FIG. 4 illustrates a first specific example of setting information stored on a setting information memory of a first exemplary embodiment of the disclosure;

FIG. 5 illustrates a specific example of application (app) information that an app information acquisition unit has acquired in a first operation example of the first exemplary embodiment of the disclosure;

FIG. 6 illustrates a first combination grant screen displayed in the first operation example of the first exemplary embodiment of the disclosure;

FIG. 7 illustrates an information collection grant screen displayed in the first exemplary embodiment of the disclosure;

FIG. 8 illustrates an information selection screen displayed in the first exemplary embodiment of the disclosure;

FIG. 9 illustrates a specific example of app information that the app information acquisition unit has acquired in a second operation example of the first exemplary embodiment of the disclosure;

FIG. 10 illustrates a second combination grant screen displayed in the second operation example of the first exemplary embodiment of the disclosure;

FIG. 11 illustrates a specific example of the app information that the app information acquisition unit has acquired in a third operation example of the first exemplary embodiment of the disclosure;

FIG. 12 illustrates an installation grant screen displayed in the third operation example of the first exemplary embodiment of the disclosure; and

FIG. 13 illustrates a second specific example of the setting information stored on the setting information memory of the first exemplary embodiment of the disclosure.

### DETAILED DESCRIPTION

Exemplary embodiments of the disclosure are described with reference to the attached drawings.

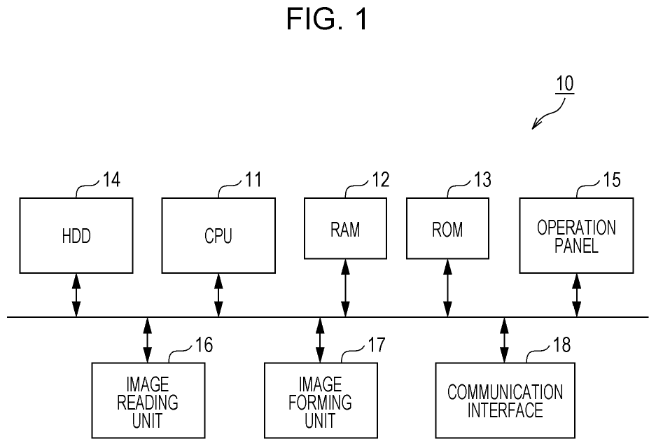

FIG. 1 illustrates a hardware configuration of an image processing apparatus 10 of an exemplary embodiment of the disclosure. Referring to FIG. 1, the image processing apparatus 10 includes a central processing unit (CPU) 11, random-access memory (RAM) 12, read-only memory (ROM) 13, hard disk drive (HDD) 14, operation panel 15, image reading unit 16, image forming unit 17, and communication interface (I/F) 18.

The CPU 11 implements the functions described below by loading a variety of programs from the ROM 13 to the RAM 12 and executing the programs.

The RAM 12 serves as a working memory for the CPU 11. The ROM 13 stores the variety of programs that are executed by the CPU 11. The HDD 14 is a magnetic disk device that stores image data read by the image reading unit 16 and image data that the image forming unit 17 uses to form an image.

The operation panel 15 is a touch panel that displays a variety of information and receives an operation input by a user. The operation panel 15 includes a display that display a variety of information and a location detecting sheet that detects a location indicated by a pointer such as a finger or a stylus pen.

The image reading unit 16 reads an image recorded on a recording medium, such as a paper sheet. For example, the image reading unit 16 is a scanner and may be a charge-coupled device (CCD) system or a contact image sensor (CIS) system. A light source emits a light beam to an original document and the CCD system receives in a contracted form via a lens a light beam reflected from the original document which is irradiated with the light beam from the light source. The CIS system receives a light beam reflected from an original document which is irradiated with a light beam from a light-emitting diode (LED) source.

The image forming unit 17 forms an image on a recording medium, such as a paper sheet. For example, the image forming unit 17 is a printer and may be an electrophotographic system or an ink-jet system. The electrophotographic system forms an image on a recording medium by transferring toner from a photoconductor drum to the recording medium. The ink-jet system forms an image on a recording medium by ejecting ink onto the recording medium.

The communication I/F 18 transmits or receives a variety of information to or from another apparatus via a communication network.

### First Exemplary Embodiment

In accordance with a first exemplary embodiment, the image processing apparatus 10 performs control to configure at least part of a grant setting of information collection related to usage information on the image processing apparatus 10 to be a grant setting of information collection related to an additional service if the usage information on the image processing apparatus 10 that is configured for the grant setting of the information collection is similar to usage information on the additional service that is added to the image processing apparatus 10 and is not configured for the grant setting of the information collection.

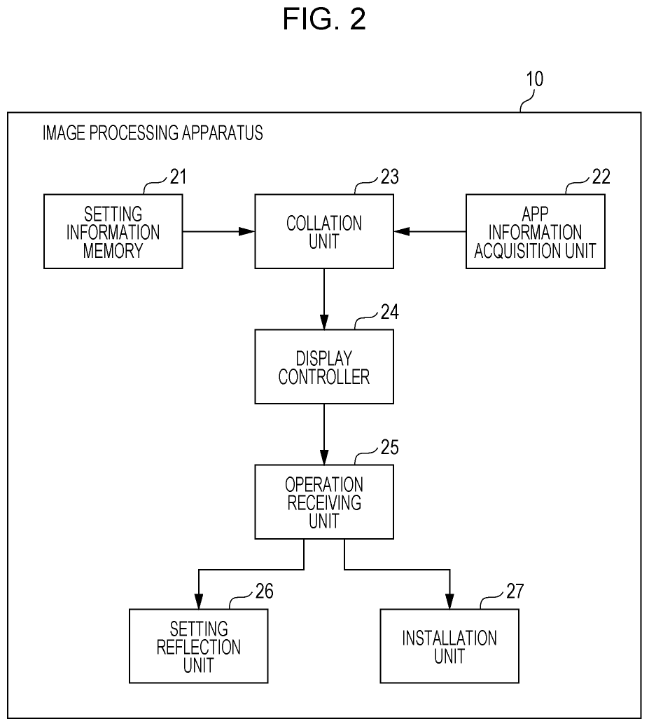

FIG. 2 is a block diagram illustrating the image processing apparatus 10 of the first exemplary embodiment of the disclosure. Referring to FIG. 2, the image processing apparatus 10 of the first exemplary embodiment includes a setting information memory 21, application (app) information acquisition unit 22, collation unit 23, display controller 24, operation receiving unit 25, setting reflection unit 26, and installation unit 27.

The setting information memory 21 stores setting information for the image processing apparatus 10. The setting information includes information items for which information collection on the image processing apparatus 10 may be restricted. On a per information item basis, the setting information includes a setting status indicating that the grant setting of the information collection is configured. If the grant setting of the information collection is configured, the setting information includes the grant setting. The setting information further includes information that indicates on a per setting information basis whether the setting information is service information or application programming interface (API) information. If the information item is information related to an operation on a specific service, that information item is service information. If the information item is acquired through API, the information item is the API information.

When a new application (app) (hereinafter referred to as a “new app”) is added to the image processing apparatus 10, the app information acquisition unit 22 acquires information included in the new app (hereinafter referred to as “app information”). The app information also includes the information item for which the information collection on the image processing apparatus 10 is restricted. The app information also includes, on a per information item basis, information indicating whether the setting information is the service information or the API information. The API information may be acquired via communication with a server (not illustrated) that manages a new app. The new app is based on the premise that the grant setting of the information collection is not yet configured.

In accordance with the first exemplary embodiment, the new app is used as an example of an additional service that is to be added to the image processing apparatus 10 and is not configured for the grant setting of the information collection. The app information acquisition unit 22 is employed as an example of a receiving unit that receives the additional service.

When the new app is added to the image processing apparatus 10, the collation unit 23 collates the information item configured for the grant setting of the information collection in the setting information stored on the setting information memory 21 with the information item in the app information acquired by the app information acquisition unit 22 and thus determines whether these information items are similar to each other. For example, a matching rate serving as the degree of similarity between the information item configured for the grant setting of the information collection in the setting information stored on the setting information memory 21 and the information item in the app information acquired by the app information acquisition unit 22 is equal to or above a predetermined threshold value, the collation unit 23 may determine that the information items are similar to each other. In such a case, if information items, each having the matching rate equal to or above the predetermined threshold value, from among the information items in the app information acquired by the app information acquisition unit 22 are included in the information items configured for the grant setting of the information collection in the setting information stored on the setting information memory 21, the collation unit 23 may determine that the matching rate is equal to or above the predetermined threshold value. The determination as to whether the matching rate is equal to or above the predetermined threshold value may be separately performed from the information item of the service information and the information item of the API information. In addition, the collation unit 23 may determine whether the matching rate is equal to or above the predetermined threshold value by using a weighting factor indicating the degree of importance configured for each the information items in the setting information stored on the setting information memory 21.

In accordance with the first exemplary embodiment, the information item is used as an example of the usage information on the image processing apparatus 10. The collation unit 23 performs the function of a controller that determines whether the usage information on the image processing apparatus 10 for which the grant setting of the information collection is configured is similar to usage information on the additional service. The matching rate is used as the degree of similarity of a type of the usage information on the image processing apparatus 10 to a type of the usage information on the additional service. The predetermined threshold value is used as an example of predetermined criteria. If the degree of similarity satisfies the predetermined criteria, the controller determines that the usage information on the image processing apparatus 10 is similar to the usage information on the additional service. In this case, the collation unit 23 performs the function of the controller. If multiple types of the usage information on the additional service equal to or above the predetermined threshold value are included in multiple types of the usage information on the image processing apparatus 10, the controller determines that the degree of similarity satisfies the predetermined reference. In this case, the collation unit 23 performs the function of the controller. A weighting factor is used as an example of an index indicating the degree of importance. The controller determines whether the degree of similarity satisfies the predetermined criteria by using the index that is configured for each of the types of the usage information on the image processing apparatus 10. The collation unit 23 performs the function of the controller in this case as well.

The new app may now be added to the image processing apparatus 10. If the collation unit 23 determines that the information item configured for the grant setting of the information collection in the setting information stored on the setting information memory 21 is similar to the information item in the app information acquired by the app information acquisition unit 22, the display controller 24 performs control to display on the operation panel 15 a combination grant screen that combines an installation grant screen used to acquire a grant for installation and an information collection grant screen used to acquire a grant for the information collection. The combination grant screen includes a first combination grant screen and a second combination grant screen. The first combination grant screen is used when matching rates of all the information items are equal to or above a threshold value and matching rates of the information items as the service information are equal to or above the threshold value. Since the matching rate of the information item as the service information is equal to or above the threshold value, the first combination grant screen notifies the user that the operation of the new app is similar to the operation of a specific service. The second combination grant screen is used when the matching rates of all the information items are equal to or above the threshold value but the matching rates of the information items as the service information are below the threshold value. Since the matching rates of the information items as the service information are below the threshold value, the second combination grant screen does not mentions the specific service but notifies the user that the operation of the new app is close to the operation of the image processing apparatus 10. If a specific information item determined as having a higher degree of importance in the setting information stored on the setting information memory 21 is included in the app information acquired by the app information acquisition unit 22, the display controller 24 performs control to display the combination grant screen on the operation panel 15.

In accordance with the first exemplary embodiment, a verification screen is used to verify whether at least part the grant setting of the information collection related to the usage information on the image processing apparatus 10 is configurable as the grant setting of the information collection related to the additional service. The information collection grant screen is used as an example of the verification screen. The display controller 24 that performs control to display the information collection grant screen serves as an example of the display controller that displays the verification screen. The information item as the setting information is used as an example of the usage information related to a service and the API information is used as an example of the usage information other than the usage information related to the service. If the usage information related to the service out of the usage information on the image processing apparatus 10 is not similar to the usage information related to the service out of the usage information on the additional service and usage information other than the usage information related to the service out of the usage information on the image processing apparatus 10 is similar to usage information other than the usage information related to the service out of the usage information on the additional service, the display controller causes the verification screen. The display controller 24 performs control to display the installation grant screen that is combined with the second combination grant screen and the display controller 24 thus serves as an example of the display controller that displays the verification screen. If specific usage information determined as having a higher degree of importance out of the usage information on the image processing apparatus 10 is included in the usage information on the additional service, the display controller performs control to display the information collection grant screen. The display controller 24 that performs control to display the installation grant screen serves as the display controller. The display controller performs control to display the verification screen that indicates that the addition of the additional service to the image processing apparatus 10 is complete. The display controller 24 serves the function of the display controller.

The new app may now be added to the image processing apparatus 10. If the collation unit 23 determines that the information item configured for the grant setting of the information collection in the setting information stored on the setting information memory 21 is not similar to the information item in the app information acquired by the app information acquisition unit 22, the display controller 24 performs control to display the installation grant screen on the operation panel 15 (see FIG. 1).

The operation receiving unit 25 receives an operation of a user (user operation) on the combination grant screen or the installation grant screen displayed on the operation panel 15 (see FIG. 1) under the control of the display controller 24. The user operations performed on the combination grant screen include an operation to grant all of installation and information collection, an operation to grant the installation only, and an operation to deny. The operations performed on the installation grant screen include an operation to grant and an operation to deny.

If the operation receiving unit 25 receives the operation to grant all the installation and information collection on the combination grant screen displayed on the operation panel 15 (see FIG. 1) under the control of the display controller 24, the setting reflection unit 26 reflects the grant setting of the information collection in the setting information stored on the setting information memory 21 on the information item in the app information acquired by the app information acquisition unit 22. Specifically, the grant setting is stored on a memory region which is referenced to verify that the information collection is granted when the new app collects information.

In accordance with the first exemplary embodiment, if the usage information on the image processing apparatus 10 with the grant setting of the information collection configured therewithin is similar to the usage information on the additional service, the controller configures at least part of the grant setting of the information collection related to the usage information on the image processing apparatus 10 to be the grant setting of the information collection related to the additional service. The setting reflection unit 26 operates as an example of the controller herein.

If the operation receiving unit 25 receives the operation to grant the installation only on the combination grant screen displayed on the operation panel 15 (see FIG. 1) under the control of the display controller 24, the installation unit 27 installs the new app onto the image processing apparatus 10. Alternatively, if the operation receiving unit 25 receives the operation to grant on the installation grant screen displayed on the operation panel 15 under the control of the display controller 24, the installation unit 27 installs the new app onto the image processing apparatus 10.

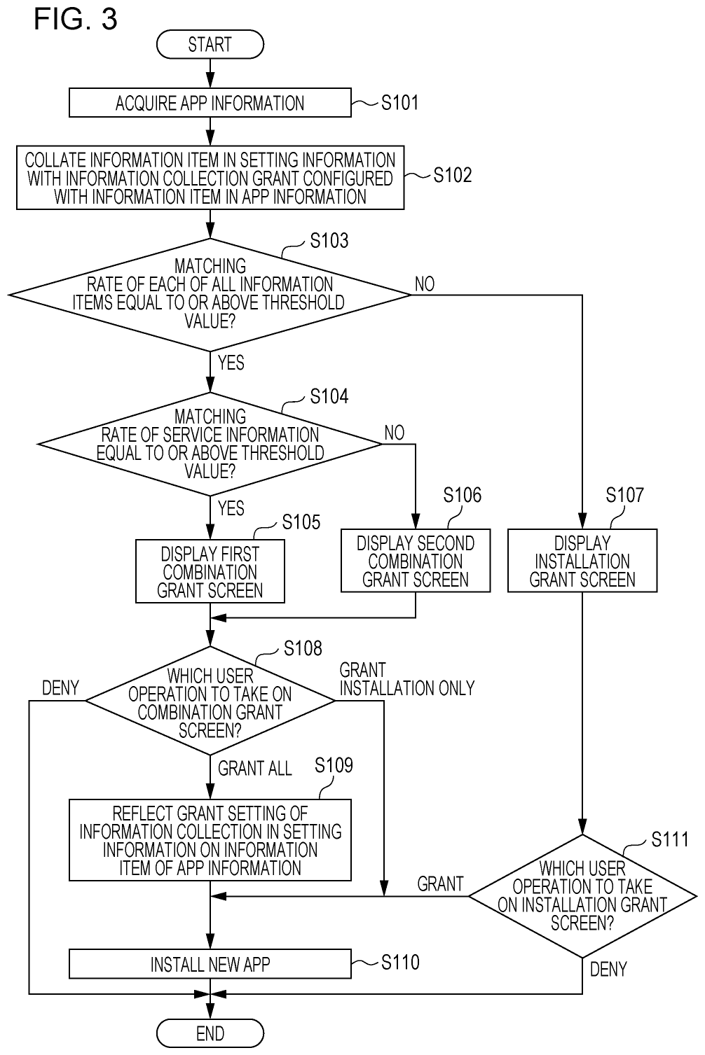

FIG. 3 is a flowchart illustrating the process of the image processing apparatus 10 of the first exemplary embodiment. The process of the flowchart starts when an user operation to add the new app is performed on the operation panel 15 (see FIG. 1).

When the process starts, the app information acquisition unit 22 in the image processing apparatus 10 acquires app information (step S101).

The collation unit 23 collates the information item configured for the grant setting of the information collection in the setting information stored on the setting information memory 21 with the information item in the app information acquired in step S101 (step S102). The collation unit 23 determines whether the matching rate of each of all the information items is equal to or above the predetermined threshold value (step S103).

If each of all the information items has a matching rate equal to or above the predetermined threshold value, the collation unit 23 determines whether the matching rate of the information item as the service information is equal to or above the predetermined threshold value (step S104). If the collation unit 23 determines that the matching rate of the information item as the service information is equal to or above the predetermined threshold value, the display controller 24 performs control to display the first combination grant screen on the operation panel 15 (see FIG. 1) (step S105). If the collation unit 23 determines that the matching rate of the information item as the service information is below the predetermined threshold value, the display controller 24 performs controls to display the second combination grant screen on the operation panel 15 (step S106). As previously described, each of the first combination grant screen and the second combination grant screen is a combination of the installation grant screen used to acquire the grant for the installation and the information collection grant screen used to acquire the grant for the information collection. The first combination grant screen is used to notify that the operation of the new app is close to the operation of a specific service while the second combination grant screen does not mention the specific service but is used to notify that the operation of the new app is close to the operation of the image processing apparatus 10.

If it is determined in step S103 that the matching rate of each of all the information items is below the predetermined threshold value, the display controller 24 performs control to display the installation grant screen on the operation panel 15 (see FIG. 1) (step S107).

After the combination grant screen is displayed on the operation panel 15 in step S105 or S106, the operation receiving unit 25 determines the user operation performed on the combination grant screen (step S108).

The user operation determined may be the operation to grant all the installation and information collection. In such a case, the setting reflection unit 26 reflects the information item, configured for the grant setting of the information collection in the setting information stored on the setting information memory 21, on the information item in the app information acquired in step S101 (step S109). The installation unit 27 installs the new app onto the image processing apparatus 10 (step S110).

The user operation determined in step S108 may be the operation to grant the installation only. In such a case, the setting reflection unit 26 does not reflect the information item, configured for the grant setting of the information collection in the setting information stored on the setting information memory 21, on the information item in the app information acquired in step S101 and the installation unit 27 installs the new app onto the image processing apparatus 10 (step S110).

The user operation determined in step S108 may be the operation to deny. In such a case, the setting reflection unit 26 does not reflect the information item, configured for the grant setting of the information collection in the setting information stored on the setting information memory 21, on the information item in the app information acquired in step S101 and the installation unit 27 does not install the new app onto the image processing apparatus 10. The process then ends.

With the installation grant screen displayed on the operation panel 15 in step S107, the operation receiving unit 25 determines the user operation performed on the installation grant screen (step S111).

The process to be performed with the user operation being the operation to grant is described below. The installation unit 27 installs the new app onto the image processing apparatus 10 (step S110).

The process to be performed with the user operation determined in step S111 being the operation to deny is described below. The process ends without the installation unit 27 installing the new app onto the image processing apparatus 10.

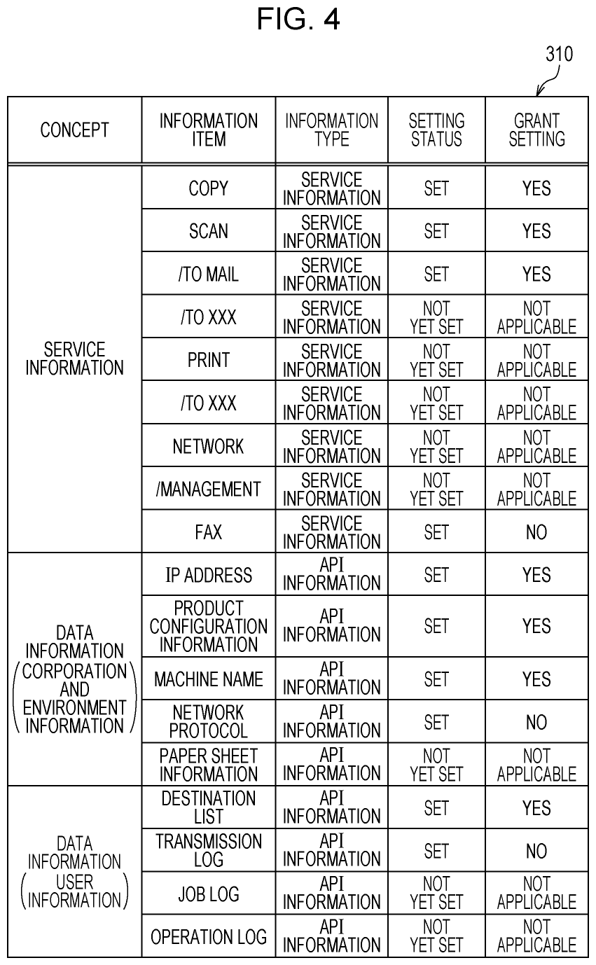

FIG. 4 illustrates, as a first specific example of setting information, setting information 310 stored on the setting information memory 21. The process of the image processing apparatus 10 is described below on the premise that the setting information 310 is stored on the setting information memory 21.

The setting information 310 is specifically described. Referring to FIG. 4, the setting information 310 associates a concept, information item, information type, setting status, and grant setting with each other.

The concept indicates classification of information items in terms of meaning. For example, the concept includes service information and data information as classifications. The service information relates to an app of the image processing apparatus 10. The data information relates to data handled by the image processing apparatus 10. The data information is divided into corporation and environment information and user information. The corporation and environment information includes information related to a company, such as an IP address and product configuration information of the company. The user information includes information set by the user, such as a destination table. The concept may further include classification of high-security information. Information having a high level of security is classified as the high-security information. For example, the user may classify a user identity (ID), account ID, and password as the high-security information. The concept may be understood as being listed for management of the information item and may not necessarily be stored as data on the setting information memory 21.

The information item is related to information, the collection of which is restrictable on the image processing apparatus 10 and is a unit of setting in accordance with which the information collection is granted. An information item with a leading symbol “/” classified as the setting information is described following an information item without the leading symbol “/” and these information items thus represent a meaningful service. For example, “/to mail” is described following “scan” represents a meaningful service “scan to mail”.

The information type is a type of a corresponding information item. The corresponding information item is classified in terms of an acquisition unit therefor. The information types include the service information and the API information. If the corresponding information item is acquired via an operation of a service of the image processing apparatus 10, the information type of the corresponding information item is service information. If the corresponding information item is acquired via API of an app program implementing a service of the image processing apparatus 10, the information type of the information item is API information.

The setting status is information indicating whether the grant setting of the information collection is configured for each corresponding information item. The word “set” indicates that the grant setting of the information collection is configured and the phrase “not yet set” indicates that the grant setting of the information collection is not yet configured.

The grant setting indicates whether the information collection is granted for the corresponding information item. The grant setting is also referred to as an operation setting related to the operation of the image processing apparatus 10. Referring to FIG. 4, “yes” represents the information collection that is granted, “no” represents the information collection that is not granted, and “not applicable” represents the grant setting of the information collection that is not yet configured. Whether to grant the information collection of the information item that is the API information may be determined based on the grant setting for the information item that is the service information indicating a service performing the information collection. For example, if the grant setting for the information item as the service information is yes, the information collection of the information item that is the API information collected via the service indicated by the service information is granted regardless of yes or no status. If the grant setting for the information item as the service information is no, the information collection of the information item that is the API information collected via the service indicated by the service information may be denied regardless of yes or no status.

The addition of the new app may now be requested and the app information acquisition unit 22 may acquire app information. A process to be performed next is described below. Three types of app information may now be acquired by the app information acquisition unit 22 and thus three operation examples corresponding to the three types of app information, first through third operation examples, are described below. The threshold value used in step S103 in FIG. 3 is 50% of all the information items of the app information. The threshold value used in step S104 in FIG. 3 is 50% of the information items in the app information in which the information type is the service information. The individual grant setting of the information collection with the operation to grant the installation only performed on the combination grant screen or with the operation to grant is performed on the installation grant screen has not been described yet. The individual grant setting of the information collection is described below.

In the first operation example, the new app is “scan to XXX”. Note that “XXX” does not represent email.

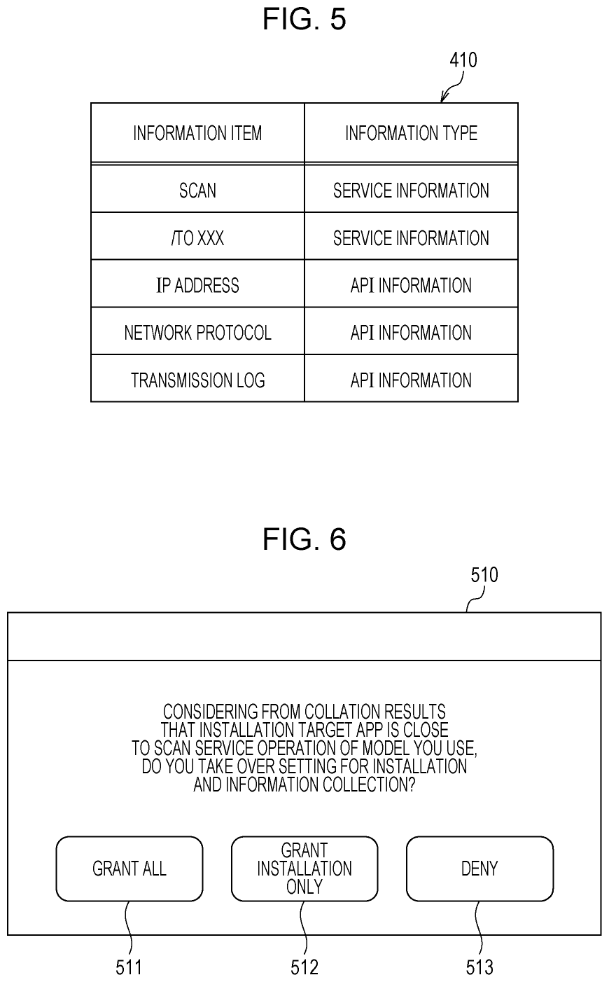

FIG. 5 illustrates app information 410 that the app information acquisition unit 22 has acquired in step S101 in the first operation example. Referring to FIG. 5, the app information 410 associates the information item with the information type. The information item and information type have been described with reference to FIG. 4.

When the app information acquisition unit 22 acquires the app information 410 in FIG. 5 in step S101, the collation unit 23 collates in step S102 the setting statuses “set” in the setting information 310 in FIG. 4 with the information items in the app information 410 in FIG. 5. The collation unit 23 herein references the setting status of the setting information 310 in FIG. 4 and the information items in the app information 410 in FIG. 5 is that the setting statuses for “scan”, “IP address”, “network protocol”, and “transmission log” are “set”, and the setting status for “/to XXX” is “not yet set”.

Since the setting statuses for four types of the information items out of five information items as all the information items in the app information 410 are “set”, the collation unit 23 determines in step S103 that the matching rate is 50% or more.

Since the setting status for one type of information item out of the two types of information item with the service type being the service information in the app information 410 is “set”, the collation unit 23 determines in step S104 that the matching rate is 50% or more.

In step S105, the display controller 24 performs control to display on the operation panel 15 the first combination grant screen that is a combination of the installation grant screen and the information collection grant screen.

The grant process succeeding to the above process is described below.

FIG. 6 illustrates a first combination grant screen 510. In the first operation example, out of the information items with the information type being the service information in the app information 410, the collation unit 23 configures in step S102 the information item “scan” to be “set”. A message indicating “close to scan service operation” displayed in the first combination grant screen 510 is notified to the user.

In step S108, the operation receiving unit 25 receives a user operation on the first combination grant screen 510 and determines operation contents.

If the user operation is an operation to press a button 513 on the first combination grant screen 510, the grant setting (operation setting) in the setting information 310 is not taken over into the new app and the new app is not installed.

If the user operation is an operation to press a button 511 on the first combination grant screen 510, the setting reflection unit 26 takes over in step S109 the grant setting (operation setting) in the setting information 310. Specifically, the setting reflection unit 26 references the grant setting in the setting information 310 in FIG. 4 and takes over “yes” for the information items “scan” and “IP address” and “no” for the information items “network protocol” and “transmission log” in the app information 410 in FIG. 5. On the other hand, since the setting status for the information item “/to XXX” in the setting information 310 in FIG. 4 is “not yet set”, the setting reflection unit 26 does not take over the grant setting for “/to XXX” in the app information 410 in FIG. 5. In such a case, the installation unit 27 installs the new app onto the image processing apparatus 10 in step S110.

If the user operation is an operation to press a button 512 on the first combination grant screen 510, processing proceeds to a process to perform only the installation of the new app. Note that when the new app is installed, the type of the information with the collection thereof granted may be set to be selectable.

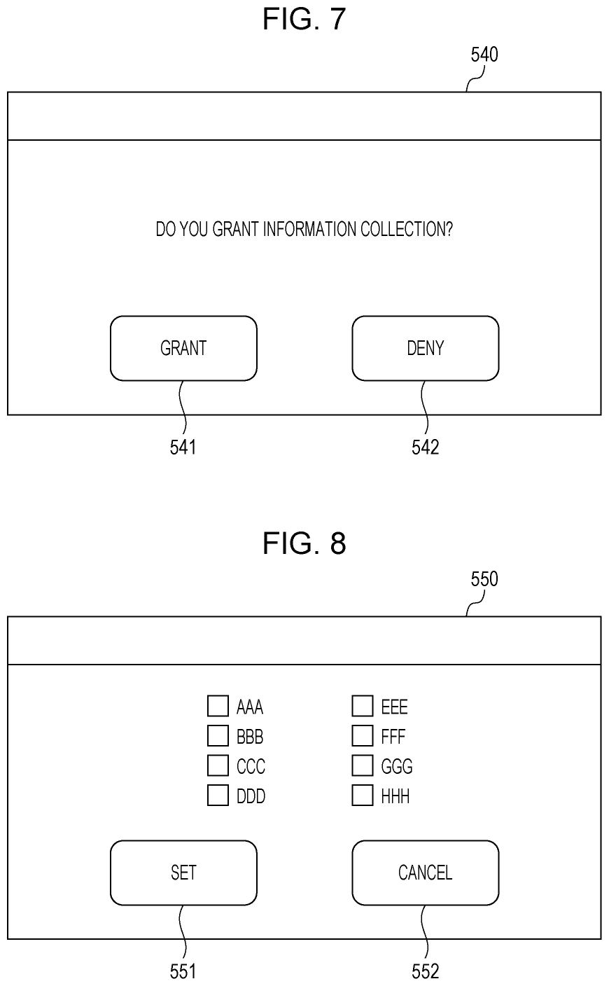

FIG. 7 illustrates an information collection grant screen 540. If the button 512 is pressed on the first combination grant screen 510, the information collection grant screen 540 is displayed. If a button 542 is pressed on the information collection grant screen 540, the process simply ends. If a button 541 is pressed, the user is allowed to select the type of the information with the collection thereof granted.

FIG. 8 illustrates an information selection screen 550 that is used to allow the user to select the type of the information with the collection thereof granted. By checking sequentially information items “AAA”, “BBB”, . . . , and by pressing a button 551, the information items checked are granted for the information collection. On the other hand, if a button 552 is pressed, the information collection is not granted.

The second operation example is the case in which the new app is “network management”.

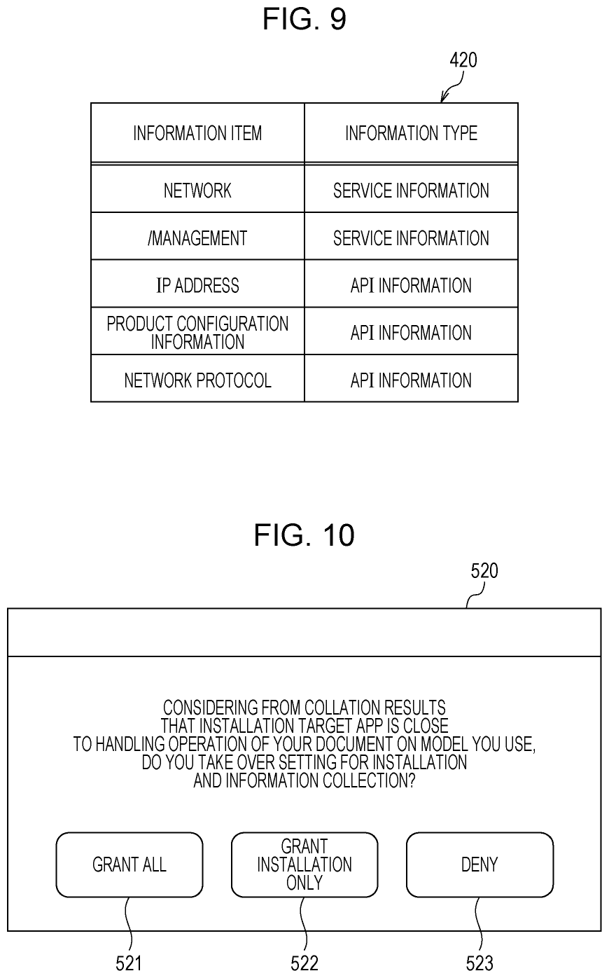

FIG. 9 illustrates app information 420 that the app information acquisition unit 22 has acquired in step S101 in the second operation example. Referring to FIG. 9, the app information 420 associates the information item with the information type. The information item and information type have previously described with reference to FIG. 4.

When the app information acquisition unit 22 acquires the app information 420 in FIG. 9 in step S101, the collation unit 23 collates in step S102 the information items having the setting status “set” in the setting information 310 in FIG. 4 with the information items in the app information 420 in FIG. 9. The collation unit 23 herein references the setting status in the setting information 310 in FIG. 4. Out of the information items in the app information 420 in FIG. 9, setting statuses for “IP address”, “product configuration information”, and “network protocol” are “set” and setting statuses for “network” and “/management” are “not yet set”.

Out of the five information items as all the information items in the app information 420, the setting statuses for three types are “set”, and the collation unit 23 determines in step S103 that the matching rate is 50% or more.

Out of the two types of information item with the information type being the service information in the app information 420, the two setting statuses of all the information items are “not yet set” and the collation unit 23 determines in step S104 that the matching rate is less than 50%.

In step S106, the display controller 24 performs control to display on the operation panel 15 the second combination grant screen that is a combination of the installation grant screen and the information collection grant screen.

The grant process succeeding to the above process is described.

FIG. 10 illustrates a second combination grant screen 520. In the second operation example, the collation unit 23 determines in step S102 that the matching rate of the information item with the information type being the service information in the app information 420 is less than 50% and the collation unit 23 performs the collation on the information item with the information type being the API information in the app information 420. The collation is performed on the API information that is not visible to a user. Even if a message indicating “close to the operation of the network” is displayed on a second combination grant screen 520, no clear relationship is provided and there is a possibility that the information collection is not granted. For this reason, a message indicating “close to handling operation of your document” that is similar to an actual workflow is displayed to the user on the second combination grant screen 520.

In step S108, the operation receiving unit 25 receives a user operation on the second combination grant screen 520 and determines operation contents of the user operation.

If the user operation is an operation to press a button 523 on the second combination grant screen 520, the grant setting (operation setting) in the setting information 310 is not taken over into the new app and the new app is not installed.

If the user operation is an operation to press a button 521 on the second combination grant screen 520, the setting reflection unit 26 takes over the grant settings (operation settings) in the setting information 310 into the new app in step S109. Specifically, the setting reflection unit 26 references the grant settings of the setting information 310 in FIG. 4 and takes over “yes” for “IP address” and “product configuration information” and “no” for “network protocol”. On the other hand, since the setting statuses for “network” and “/management” in the information items in the setting information 310 in FIG. 4 are “not yet set”, the setting reflection unit 26 does not take over the grant settings for “network” and “/management” in the app information 420 in FIG. 9. In this case, the installation unit 27 installs the new app onto the image processing apparatus 10 in step S110.

If the user operation is an operation to press a button 522 on the second combination grant screen 520, processing proceeds to a process to perform only the installation of the new app. When only the installation of the new app is performed, the type of the information with the collection thereof granted may be set to be selectable. The process of setting the type of the installation with the collection thereof granted to be selectable has been described with reference to FIGS. 7 and 8.

A third operation example is the case in which the new app is “print to XXX”.

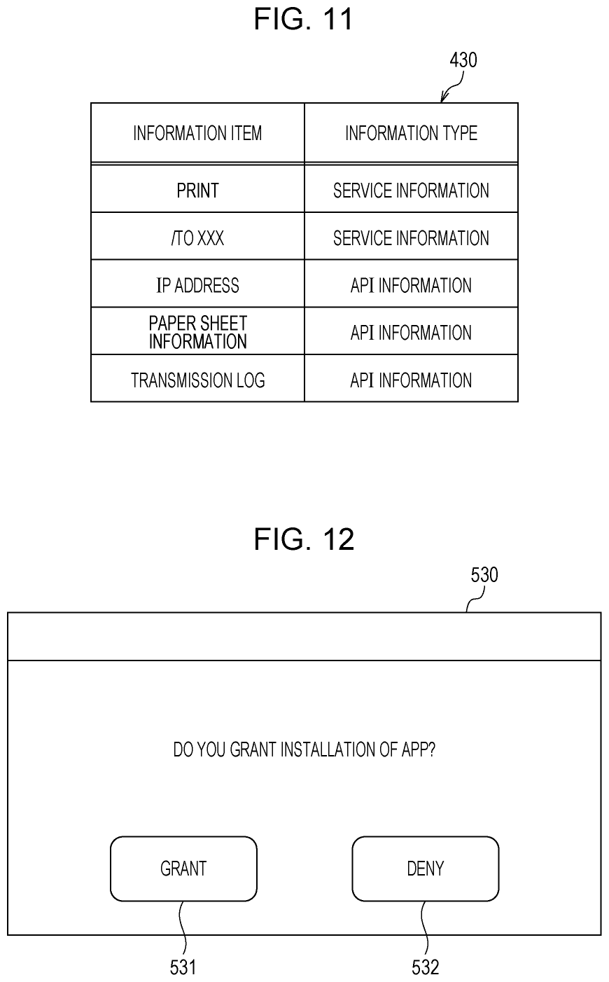

FIG. 11 illustrates app information 430 that the app information acquisition unit 22 has acquired in the third operation example in step S101 in the third operation example. Referring to FIG. 11, the app information 430 also associates the information item with the information type. The information item and information type have described with reference to FIG. 4.

When the app information acquisition unit 22 has acquired the app information 430 in step S101, the collation unit 23 collates the information items with the setting status being “set” in the setting information 310 in FIG. 4 with the information items in the app information 430 in FIG. 11. The collation unit 23 references the setting statuses in the setting information 310 in FIG. 4. Out of the information items in the app information 430 in FIG. 11, the setting statuses for “IP address” and “transmission log” are “set” and the setting statuses for “print”, “/to XXX”, and “paper sheet” are “not yet set”.

Since the setting statuses for two types of information items out of all of, namely, five types of information items in the app information 430 are “set”, the collation unit 23 determines in step S103 that the matching rate is less than 50%.

In step S107, the display controller 24 performs control to display the installation grant screen on the operation panel 15.

The grant process succeeding to the above process is described below.

FIG. 12 illustrates an installation grant screen 530. A message asking a user whether the user grants the installation of a new app is displayed on the installation grant screen 530.

In step S111, the operation receiving unit 25 receives a user operation on the installation grant screen 530 and determines operation contents.

If the user operation is an operation to press a button 532 on the installation grant screen 530, the installation of the new app is not performed.

If the user operation is an operation to press a button 531 on the installation grant screen 530, the installation unit 27 proceeds to a process to perform only the installation of the new app in step S110. When only the installation of the new app is performed, the type of the information with the collection thereof granted may be set to be selectable. The process of enabling to be selectable the type of the information with the collection thereof granted has been described with reference to FIGS. 7 and 8.

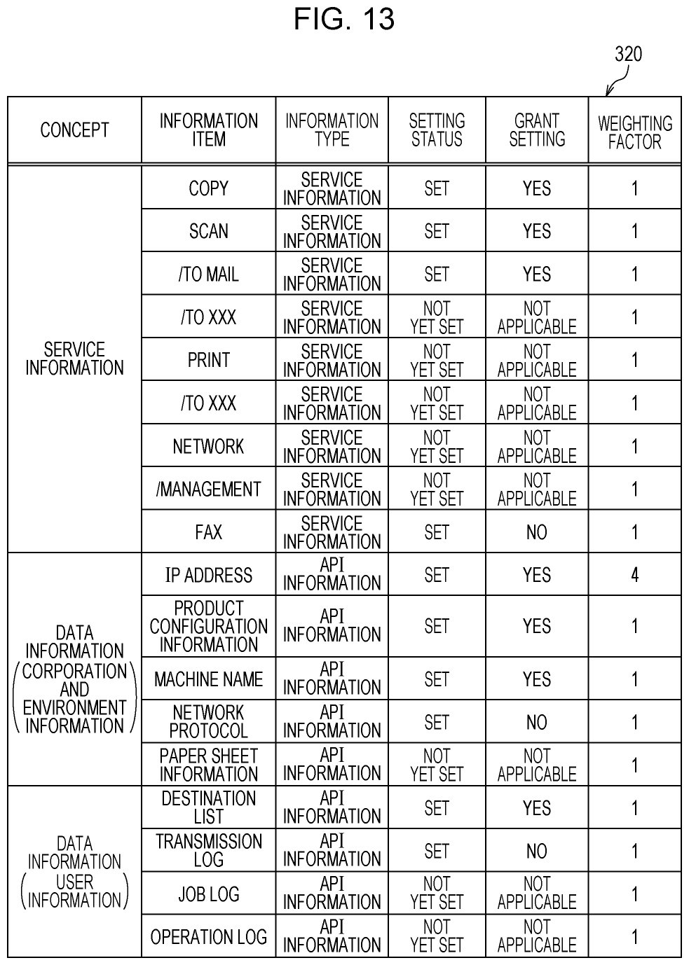

FIG. 13 illustrates, as a second specific example of setting information, setting information 320 stored on the setting information memory 21. The process of the image processing apparatus 10 is specifically described based on the premise that the setting information 320 is stored on the setting information memory 21.

The setting information 320 is described as the second specific example of setting information. Referring to FIG. 13, the setting information 320 associates the concept, information item, information type, setting status, grant setting, and weighting factor with each other.

The concept, information item, information type, setting status, and grant setting have been described in the first specific example of setting information.

The weighting factor represents a weight for each information item used to calculate the matching rate. Even if the matching rate is reduced with the same weighting factors used for the information items, the installation grant screen and information collection grant screen are combined into a single screen by increasing the matching rate. The weighting factor may be set on each image processing apparatus 10.

The second specific example of setting information is the case in which the new app is “print to XXX” as in the third operation example in the first specific example of setting information.

In the second specific example of setting information, a specific example of the app information 430 acquired by the app information acquisition unit 22 in step S101 is illustrated in FIG. 11.

When the app information acquisition unit 22 has acquired the app information 430 in step S101, the collation unit 23 collates in step S102 the information items with the setting status being “set” in the setting information 320 in FIG. 13 with the information items in the app information 430 in FIG. 11. The collation unit 23 herein references the setting statuses in the app information 320 in FIG. 13. Out of the information items in the app information 430 in FIG. 11, the setting statuses for “IP address” and “transmission log” are “set” and the setting statuses for “print”, “/to XXX”, and “paper sheet” are “not yet set”.

In the third operation example on the first example of setting information, the setting statuses of only two types of information items out of all the five types of information items in the app information 430 are “set” and the collation unit 23 determines in step S103 that the matching rate is less than 50%.

In step S107, the display controller 24 performs control to display the installation grant screen on the operation panel 15.

In the second specific example of setting information, the points of “set” are calculated to be 5 points by summing 4 points for “IP address” and 1 point for “transmission log”. The points for “not yet set” are calculated to be 3 points by summing 1 point for “print”, 1 point for “/to XXX”, and 1 point for “paper sheet”. In this way, the points for “set” are higher than the points for “not yet set”.

In step S105 or S106, the display controller 24 performs control to display the combination grant screen on the operation panel 15.

The image processing apparatus 10 performs the processes as described with reference to the first exemplary embodiment. An ordinary information process processing apparatus may perform the processes of the first exemplary embodiment.

### Second Exemplary Embodiment

In accordance with a second exemplary embodiment, the image processing apparatus 10 performs control to configure at least part of the grant setting of the information collection related to an existing service to be the grant setting of the information collection related to an additional service if the existing service of the image processing apparatus 10 with the grant setting of the information collection configured for is similar to the additional service that is to be added to the image processing apparatus 10 and is not configured for the grant setting of the information collection.

FIG. 2 is also the functional block diagram of the image processing apparatus 10 of the second exemplary embodiment. The image processing apparatus 10 of the second exemplary embodiment also includes the setting information memory 21, app information acquisition unit 22, collation unit 23, display controller 24, operation receiving unit 25, setting reflection unit 26, and installation unit 27.

The setting information memory 21 stores the setting information on the image processing apparatus 10. The setting information of the second exemplary embodiment is identical to the setting information of the first exemplary embodiment except that the information item as the service information does not include the setting status and grant setting.

The app information acquisition unit 22 is identical to the app information acquisition unit 22 in the first exemplary embodiment.

When the new app is added to the image processing apparatus 10, the collation unit 23 collates the information item as the service information in the setting information stored on the setting information memory 21 with the information item as the service information in the app information acquired by the app information acquisition unit 22 to determine whether the information items are similar to each other. If the degree of similarity between a name and category of the information item as the service information in the setting information stored on the setting information memory 21 are similar to a name and category of the information item as the service information in the app information acquired by the app information acquisition unit 22 is a matching rate equal to or above a predetermined threshold, these information items may be determined to be similar to each other.

In accordance with the second exemplary embodiment, an example of the existing service on the image processing apparatus 10 is the information item. The collation unit 23 serves as the controller that determines whether the existing service on the image processing apparatus 10 that is configured for the grant setting of the information collection is similar to the additional service.

The new app may be added to the image processing apparatus 10. If the collation unit 23 determines that the information item as service information in the setting information stored on the setting information memory 21 is similar to the information item as the service information in the app information acquired by the app information acquisition unit 22, the display controller 24 performs control to display on the operation panel 15 (see FIG. 1) the combination grant screen that is a combination of the installation grant screen used to obtain a grant to install and the information collection grant screen used to obtain a grant to collect information.

The new app may be added to the image processing apparatus 10. If the collation unit 23 determines that the information item as the service information in the setting information stored on the setting information memory 21 is not similar to the information item as the service information in the app information acquired by the app information acquisition unit 22, the display controller 24 performs control to display the installation grant screen on the operation panel 15 (see FIG. 1).

The operation receiving unit 25, setting reflection unit 26, and installation unit 27 are identical to those of the first exemplary embodiment and the discussion thereof is omitted herein.

In accordance with the second exemplary embodiment, if the existing service of the image processing apparatus 10 with the grant setting of the information collection configured is similar to the additional service, the setting reflection unit 26 serves as the controller that configures at least part of the grant setting of the information collection related to the existing service to be the grant setting of the information collection related to the additional service.

The flowchart of the process of the image processing apparatus 10 in accordance with the second exemplary embodiment is identical to the flowchart in FIG. 3 except the following points. The flowchart of the second exemplary embodiment is different from the flowchart in FIG. 3 in step S102. In step S102, the collation unit 23 collates the information item as the service information in the setting information stored on the setting information memory 21 with the information item as the service information in the app information acquired in step S101. The flowchart of the second exemplary embodiment is further different from the flowchart in FIG. 3 as below. If the collation unit 23 in step S103 determines that the information items are similar to each other, the determination in step S104 is not performed and the display controller 24 performs control to display the combination grant screen on the operation panel 15 (see FIG. 1).

Although the image processing apparatus 10 performs the process of the second exemplary embodiment, an ordinary information processing apparatus may perform the process of the second exemplary embodiment. For example, the information processing apparatus may be a portable terminal, such as a smart phone, and a new app may be added to the portable terminal. If an existing app is similar to the new app, the grant setting of the information collection configured in the existing app may be reflected on the new app. The similarity between the existing app and the new app may be determined by accounting for a similarity of an app name, whether the apps belong to the same category (for example, belong to the same social networking service (SNS) category), or the like.

The process of the image processing apparatus 10 of the second exemplary embodiment may be provided in the form of app software, namely, programs.

A first program implementing the exemplary embodiments causes a computer to execute a process for processing information. The process includes receiving an additional service that is to be added to an information processing apparatus and is not configured for a grant setting of information collection, and if usage information on the information processing apparatus that is configured for the grant setting of the information collection is similar to the usage information on the additional service, performing control to configure at least part of the grant setting of the information collection related to the usage information on the information processing apparatus to be the grant setting of the information collection related to the additional service.

A second program implementing the exemplary embodiments causes a computer to execute a process for processing information. The process includes receiving an additional service that is to be added to an information processing apparatus and is not configured for a grant setting of information collection, and if an existing service on the information processing apparatus that is configured for the grant setting of the information collection is similar to the additional service, performing control to configure at least part of the grant setting of the information collection related to the existing service to be the grant setting of the information collection related to the additional service.

The program implementing the exemplary embodiments may be provided not only via a communication medium but also by storing the program on a recording medium, such as a compact disk read-only memory (CD-ROM).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiment were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
a receiving unit that receives an additional service that is to be added to the information processing apparatus and is not configured for a grant setting of information collection; and
a controller that, if usage information on the information processing apparatus that is configured for the grant setting of the information collection is similar to usage information on the additional service, performs control to configure at least part of the grant setting of the information collection related to the usage information on the information processing apparatus to be the grant setting of the information collection related to the additional service.

2. The information processing apparatus according to claim 1, wherein if a degree of similarity between a type of the usage information on the information processing apparatus and a type of the usage information on the additional service satisfies predetermined criteria, the controller determines that the usage information on the information processing apparatus is similar to the usage information on the additional service.

3. The information processing apparatus according to claim 2, wherein if a plurality of types of the usage information on the information processing apparatus includes a number of types of the usage information on the additional service with the number of types being equal to or above a threshold value, the controller determines that the degree of similarity satisfies the predetermined criteria.

4. The information processing apparatus according to claim 2, wherein the controller uses an index indicating a degree of importance configured for each of the types of the usage information on the information processing apparatus in order to determine whether the degree of similarity satisfies the predetermined criteria.

5. The information processing apparatus according to claim 1, further comprising a display controller that displays a verification screen that is used to verify whether at least part of the grant setting of the information collection related to the usage information on the information processing apparatus is configurable to be the grant setting of the information collection related to the additional service.

6. The information processing apparatus according to claim 5, wherein if usage information related to service out of the usage information on the information processing apparatus is not similar to usage information related to service out of the usage information on the additional service and usage information other than the usage information related to the service out of the usage information on the information processing apparatus is similar to usage information other than the usage information related to the service out of the usage information on the additional service, the display controller causes the verification screen to be displayed.

7. The information processing apparatus according to claim 5, wherein if specific usage information determined as having a higher degree of importance out of the usage information on the information processing apparatus is included in the usage information on the additional service, the display controller causes the verification screen to be displayed.

8. The information processing apparatus according to claim 5, wherein the verification screen indicating that an addition of the additional service to the information processing apparatus is complete is caused to be displayed by the display controller.

9. An information processing apparatus comprising:
a receiving unit that receives an additional service that is to be added to the information processing apparatus and is not configured for a grant setting of information collection; and
a controller that, if an existing service of the information processing apparatus that is configured for the grant setting of the information collection is similar to the additional service, performs control to configure at least part of the grant setting of the information collection related to the existing service to be the grant setting of the information collection related to the additional service.

10. A non-transitory computer readable medium storing a program causing a computer to execute a process for processing information, the process comprising:
receiving an additional service that is to be added to an information processing apparatus and is not configured for a grant setting of information collection; and
if an existing service of the information processing apparatus that is configured for the grant setting of the information collection is similar to the additional service, performing control to configure at least part of the grant setting of the information collection related to the existing service to be the grant setting of the information collection related to the additional service.
